(19) United States
(12) Patent Application Publication
(10) Pub. No.: US 2025/0291095 A1
(43) Pub. Date: Sep. 18, 2025

(54) OPTICAL FILTER

(71) Applicant: AGC Inc., Tokyo (JP)

(72) Inventors: Takashi NAGATA, Shizuoka (JP); Takahiro SAKAGAMI, Shizuoka (JP); Kazuhiko SHIONO, Fukushima (JP)

(73) Assignee: AGC Inc., Tokyo (JP)

(21) Appl. No.: 19/225,022

(22) Filed: Jun. 2, 2025

Related U.S. Application Data
(63) Continuation of application No. PCT/JP2023/045814, filed on Dec. 20, 2023.

(30) Foreign Application Priority Data
Dec. 27, 2022 (JP) 2022-210261

(51) Int. Cl. G02B 5/20

(52) U.S. Cl. CPC G02B 5/208

(57) ABSTRACT

An optical filter includes: a dielectric multilayer film 1; a substrate comprising a near-infrared ray absorbing glass and a resin film; and a dielectric multilayer film 2 in this order. The resin film includes a near-infrared ray absorbing dye, an ultraviolet ray absorbing dye, and a resin. The optical filter satisfies all of the spectral characteristics (i-1) to (i-9).

### CROSS-REFERENCE TO RELATED APPLICATIONS

This is a bypass continuation of International Application No. PCT/JP2023/045814 filed on Dec. 20, 2023, and claims priority from Japanese Patent Application No. 2022-210261 filed on Dec. 27, 2022, the entire content of which is incorporated herein by reference.

### TECHNICAL FIELD

The present invention relates to an optical filter that transmits visible light and shields near-infrared light.

### BACKGROUND ART

In an imaging device including a solid state image sensor, in order to satisfactorily reproduce a color tone and obtain a clear image, an optical filter that transmits light in a visible region (hereinafter, also referred to as “visible light”) and shields light in a near-infrared wavelength region (hereinafter, also referred to as “near-infrared light”) is used.

Examples of such an optical filter include various types such as a reflection type filter in which dielectric thin films having different refractive indices are alternately laminated (dielectric multilayer film) on one surface or both surfaces of a transparent substrate and light to be shielded is reflected by utilizing interference of light, an absorption type filter in which light to be shielded is absorbed by using a glass or a dye that absorbs light in a specific wavelength region, and a filter in which a reflection type filter and an absorption type filter are combined.
Patent Literature 1 discloses an optical filter containing a dye that absorbs light in a near-infrared region.
Patent Literature 2 discloses an optical filter including a glass that absorbs light in a near-infrared region and a reflection layer formed of a dielectric multilayer film.
Patent Literature 1: WO2019/168090
Patent Literature 2: WO2019/151348

### SUMMARY OF INVENTION

The optical filter disclosed in Patent Literature 1 has room for improvement in that the optical filter blocks light in a wide range in a near-infrared region solely by absorption characteristics of a dye, resulting in a decrease in transmittance in a visible light region.

In an optical filter utilizing reflection of a dielectric multilayer film such as the optical filter disclosed in Patent Literature 2, an optical thickness of the dielectric multilayer film changes depending on an incident angle of light, and thus there is a concern that a spectral transmittance curve and a spectral reflectance curve change depending on the incident angle. For example, when uptake of light in a visible light region changes at a high incident angle, a problem that image reproducibility is reduced may occur. In particular, with reduction in height of camera modules in recent years, use under a condition of a high incident angle is assumed, and therefore an optical filter that is less likely to be affected by an incident angle is required.

Further, reflected light is re-reflected by a lens surface and is incident, or light reflected by a sensor surface is re-reflected by a dielectric multilayer film surface and is incident, resulting in a phenomenon in which light is generated outside an originally assumed optical path, that is, so-called stray light. When such a filter is used, flare or ghost may occur in a solid state image sensor, or image quality reduction may occur. In particular, with image quality enhancement of camera modules in recent years, an optical filter in which stray light is less likely to be generated is required.

In particular, from the viewpoint of preventing the occurrence of blue flare and ghost, there is a demand for an optical filter in which reflection characteristics in an ultraviolet light region on a light incident surface side can be prevented such that the optical filter itself absorbs ultraviolet light.

An object of the present invention is to provide an optical filter in which transmissivity in a visible light region is excellent, shielding properties in a wide range of near-infrared light region including around 1200 nm is excellent, change in spectral characteristics is small even at a high incident angle, stray light is prevented, and reflection characteristics in an ultraviolet light region is small.

The present invention provides the optical filter and the like having the following configuration.

[1] An optical filter including:
a dielectric multilayer film 1;
a substrate comprising a near-infrared ray absorbing glass and a resin film; and
a dielectric multilayer film 2 in this order,
in which the resin film includes a near-infrared ray absorbing dye, an ultraviolet ray absorbing dye, and a resin, and
the optical filter satisfies all of the following spectral characteristics (i-1) to (i-9),
(i-1) an absolute value of a difference between an average transmittance T_{440-600(0deg)AVE} in a wavelength of 440 nm to 600 nm and at an incident angle of 0 degrees and an average transmittance T_{440-600(60deg)AVE} in a wavelength of 440 nm to 600 nm and at an incident angle of 60 degrees is 12% or less
(i-2) the average transmittance T_{440-600(0deg)AVE} is 78% or more
(i-3) a wavelength IR_T_{50(0deg)} at which a transmittance is 50% at an incident angle of 0 degrees is in a wavelength region of 590 nm to 640 nm
(i-4) an average transmittance T_{700-800(0deg)AVE} in a wavelength of 700 nm to 800 nm and at an incident angle of 0 degrees is 1% or less
(i-5) an average transmittance T_{800-1200(0deg)AVE} in a wavelength of 800 nm to 1200 nm and at an incident angle of 0 degrees is 5% or less
(i-6) when a dielectric multilayer film 1 side is set as an incident direction, an average reflectance R1_{370-420(5deg)AVE} in a wavelength of 370 nm to 420 nm and at an incident angle of 5 degrees is 65% or less
(i-7) when a dielectric multilayer film 1 side is set as an incident direction, a wavelength IR1_R_{50(5deg)} at which a reflectance is 50% at an incident angle of 5 degrees is in a wavelength range of 790 nm to 860 nm
(i-8) when a dielectric multilayer film 1 side is set as an incident direction, an average reflectance R1_{800-1000(5deg)AVE} in a wavelength of 800 nm to 1000 nm and at an incident angle of 5 degrees is 75% or more
(i-9) when a dielectric multilayer film 2 side is set as an incident direction, an average reflectance R2_{400-800(5deg)AVE} in a wavelength of 400 nm to 800 nm and at an incident angle of 5 degrees is 2% or less.

According to the present invention, an optical filter in which transmissivity in a visible light region is excellent, shielding properties in a wide range of near-infrared light region including around 1200 nm is excellent, change in spectral characteristics is small even at a high incident angle, stray light is prevented, and reflection characteristics in an ultraviolet light region is small can be provided.

### BRIEF DESCRIPTION OF DRAWINGS

FIG. 1 is a cross-sectional view schematically illustrating an example of an optical filter according to one embodiment.

FIG. 2 is a diagram illustrating spectral transmittance curves (0° transmittance, 60° transmittance) of an optical filter in Example 1.

FIG. 3 is a diagram illustrating spectral reflectance curves (5° reflectance, 60° reflectance, dielectric multilayer film 1 side) of the optical filter in Example 1.

FIG. 4 is a diagram illustrating spectral reflectance curves (5° reflectance, 60° reflectance, dielectric multilayer film 2 side) of the optical filter in Example 1.

FIG. 5 is a diagram illustrating spectral transmittance curves (0° transmittance, 60° transmittance) of an optical filter in Example 2.

FIG. 6 is a diagram illustrating spectral transmittance curves (0° transmittance, 60° transmittance) of an optical filter in Example 3.

FIG. 7 is a diagram illustrating spectral reflectance curves (5° reflectance, 60° reflectance, dielectric multilayer film 1 side) of the optical filter in Example 3.

FIG. 8 is a diagram illustrating spectral transmittance curves (0° transmittance, 60° transmittance) of an optical filter in Example 4.

FIG. 9 is a diagram illustrating spectral transmittance curves (0° transmittance, 60° transmittance) of an optical filter in Example 5.

### DESCRIPTION OF EMBODIMENTS

Hereinafter, embodiments of the present invention will be described.

In the present description, a near-infrared ray absorbing dye may be abbreviated as an “NIR dye”, and an ultraviolet ray absorbing dye may be abbreviated as a “UV dye”.

In the present description, a compound represented by a formula (I) is referred to as a compound (I). The same applies to compounds represented by other formulae. A dye composed of the compound (I) is also referred to as a dye (I), and the same applies to other dyes. A group represented by the formula (I) is also referred to as a group (I), and the same applies to groups represented by other formulae.

In the present description, an internal transmittance is a transmittance obtained by subtracting an influence of interface reflection from a measured transmittance, which is represented by a formula of {measured transmittance (incident angle of 0 degrees)/(100−reflectance (incident angle of 5 degrees))}×100.

In the present description, a transmittance of, for example, 90% or more in a specific wavelength region means that the transmittance does not fall below 90% in the entire wavelength region, that is, a minimum transmittance is 90% or more in the wavelength region. Similarly, a transmittance of, for example, 1% or less in a specific wavelength region means that the transmittance does not exceed 1% in the entire wavelength region, that is, a maximum transmittance in the wavelength region is 1% or less. The same applies to the internal transmittance. An average transmittance and an average internal transmittance in a specific wavelength region are an arithmetic mean of a transmittance and an internal transmittance per 1 nm in the wavelength region. A reflectance when a dielectric multilayer film side is set as an incident direction refers to an optical characteristic of light reflected when measurement light is incident on a surface of a dielectric multilayer film provided in an optical filter.

Spectral characteristics can be measured by using an ultraviolet-visible spectrophotometer.

In the present description, the symbol “−” or the word “to” that is used to express a numerical range includes the numerical values before and after the symbol or the word as the upper limit and the lower limit of the range, respectively.

### <Optical Filter>

An optical filter according to the present embodiment includes a dielectric multilayer film 1, a substrate including a near-infrared ray absorbing glass and a resin film, and a dielectric multilayer film 2 in this order. The resin film contains a near-infrared ray absorbing dye, an ultraviolet ray absorbing dye, and a resin.

In the present embodiment, as described later, a light shielding property of the optical filter is preferably ensured by absorption characteristics of the near-infrared ray absorbing glass, the near-infrared ray absorbing dye, and the ultraviolet ray absorbing dye, and reflection characteristics of the dielectric multilayer films. Since an influence of an incident angle of light on the absorption characteristics is relatively minor, an optical filter with a small change in spectral characteristics even at a high incident angle is obtained.

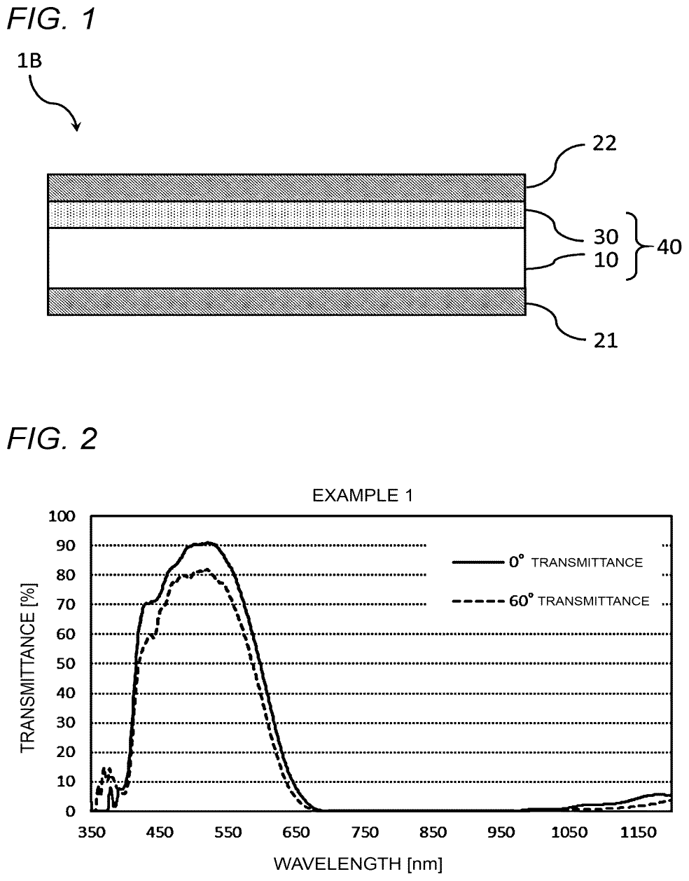

A configuration example of the optical filter according to the present embodiment is described with reference to the drawings. FIG. 1 is a cross-sectional view schematically illustrating an example of the optical filter according to one embodiment.

An optical filter 1B illustrated in FIG. 1 is an example including a dielectric multilayer film 21, a substrate 40 including a near-infrared ray absorbing glass 10 and a resin film 30, and a dielectric multilayer film 22.

The optical filter according to the present embodiment satisfies all of the following spectral characteristics (i-1) to (i-9).

(i-1) an absolute value of a difference between an average transmittance T_{440-600(0deg)AVE} in a wavelength of 440 nm to 600 nm and at an incident angle of 0 degrees and an average transmittance T_{440-600(60deg)AVE} in a wavelength of 440 nm to 600 nm and at an incident angle of 60 degrees is 12% or less
(i-2) the average transmittance T_{440-600(0deg)AVE} is 78% or more
(i-3) a wavelength IR_T_{50(0deg)} at which a transmittance is 50% at an incident angle of 0 degrees is in a wavelength region of 590 nm to 640 nm
(i-4) an average transmittance T_{700-800(0deg)AVE} in a wavelength of 700 nm to 800 nm and at an incident angle of 0 degrees is 1% or less
(i-5) an average transmittance T_{800-1200(0deg)AVE} in a wavelength of 800 nm to 1200 nm and at an incident angle of 0 degrees is 5% or less
(i-6) when a dielectric multilayer film 1 side is set as an incident direction, an average reflectance R1_{370-420(5deg)AVE} in a wavelength of 370 nm to 420 nm and at an incident angle of 5 degrees is 65% or less
(i-7) when a dielectric multilayer film 1 side is set as an incident direction, a wavelength IR1_R_{50(5deg)} at which a reflectance is 50% at an incident angle of 5 degrees is in a wavelength range of 790 nm to 860 nm
(i-8) when a dielectric multilayer film 1 side is set as an incident direction, an average reflectance R1_{800-1000(5deg)AVE} in a wavelength of 800 nm to 1000 nm and at an incident angle of 5 degrees is 75% or more
(i-9) when a dielectric multilayer film 2 side is set as an incident direction, an average reflectance R2_{400-800(5deg)AVE} in a wavelength of 400 nm to 800 nm and at an incident angle of 5 degrees is 2% or less

The optical filter according to the present embodiment, which satisfies all of the spectral characteristics (i-1) to (i-9), has high transmissivity for visible light as illustrated in the characteristic (i-2), and high near-infrared light shielding properties in a wide range of 750 nm to 1200 nm as illustrated in the characteristics (i-4) and (i-5).

As illustrated in the spectral characteristic (i-6) in which the reflection characteristic of the dielectric multilayer film is substantially reflected, a reflection characteristic in an ultraviolet light region is kept low, while the ultraviolet ray absorbing dye ensures light shielding properties in the ultraviolet light region. As illustrated in the spectral characteristic (i-8), a near-infrared light region has a certain degree of reflection characteristic, but by blocking the near-infrared region using the near-infrared ray absorbing dye, a change in spectral characteristic is small even at a high incident angle, as illustrated in the characteristic (i-1). Further, as illustrated in the spectral characteristic (i-9), the reflection characteristics on the other dielectric multilayer film side are prevented to a small value over a wide range, so that stray light is unlikely to occur.

Satisfying the spectral characteristics (i-1) and (i-2) means that a visible light transmittance does not decrease even at a high incident angle, and visible light transmissivity is excellent.

An absolute value of the difference in the spectral characteristic (i-1) is preferably 11% or less, and more preferably 10% or less.

The average transmittance T_{440-600(0deg)AVE} is preferably 79% or more, and more preferably 79.5% or more.

The spectral characteristics (i-1) and (i-2) can be achieved, for example, by using a dielectric multilayer film having a low reflectance in a visible light region, by using a near-infrared ray absorbing dye and an ultraviolet ray absorbing dye having a high transmittance in the visible light region, and by using a glass to be described later as the near-infrared ray absorbing glass.

Satisfying the spectral characteristic (i-3) means that color reproducibility, especially for a red captured image is excellent.

The wavelength IR_T_{50(0deg)} is preferably in 590 nm to 630 nm, and more preferably in 595 nm to 620 nm.

The spectral characteristic (i-3) can be achieved, for example, by using a glass to be described later as the near-infrared ray absorbing glass.

Satisfying the spectral characteristic (i-4) means that the near-infrared light shielding property is excellent.

The average transmittance T_{700-800(0deg)AVE} is preferably 0.5% or less, more preferably 0.09% or less, and still more preferably 0.08% or less.

The spectral characteristic (i-4) can be achieved, for example, by using two or more near-infrared ray absorbing dyes and using a glass to be described later as the near-infrared ray absorbing glass.

Satisfying the spectral characteristic (i-5) means that a light shielding property in the near-infrared light region up to a wide range around 1200 nm is excellent.

The average transmittance T_{800-1200(0deg)AVE} is preferably 4.6% or less, and more preferably 4.2% or less.

The spectral characteristic (i-5) can be achieved, for example, by using a glass to be described later as the near-infrared ray absorbing glass.

The spectral characteristics (i-6) to (i-9) substantially reflect the reflection characteristics of the dielectric multilayer films.

As illustrated in the spectral characteristics (i-6) to (i-8), one of the dielectric multilayer films has a small reflection characteristic in an ultraviolet region of a wavelength of 370 nm to 420 nm and a large reflection characteristic in a near-infrared region of a wavelength of 800 nm to 1000 nm.

The average reflectance R1_{370-420(5deg)AVE} is preferably 60% or less, and more preferably 58% or less.

The wavelength IR1_R_{50(5deg)} is preferably in a region of 790 nm to 850 nm, and more preferably in a region of 795 nm to 840 nm.

The average reflectance R1_{800-1000(5deg)AVE} is preferably 80% or more, and more preferably 85% or more.

As illustrated in the spectral characteristic (i-9), the other dielectric multilayer film has a low reflection characteristic in visible light having a wavelength of 400 nm to 800 nm and a wide range of near-infrared light, and functions as an anti-reflection film. Accordingly, an optical filter that provides high color reproducibility for a captured image can be provided.

The average reflectance R2_{400-800(5deg)AVE} is preferably 1.5% or less, and more preferably 1.0% or less.

The optical filter according to the present embodiment preferably satisfies all of the following spectral characteristics (i-10) and (i-11).
(i-10) a wavelength UV_T_{50(0deg)} at which a transmittance is 50% at an incident angle of 0 degrees is in a wavelength region of 400 nm to 420 nm
(i-11) an average transmittance T_{370-400(0deg)AVE} in a wavelength of 370 nm to 400 nm and at an incident angle of 0 degrees is 10% or less

Satisfying the spectral characteristic (i-10) means that color reproducibility, especially for a blue captured image is excellent.

The wavelength UV_T_{50(0deg)} is more preferably in a region of 405 nm to 420 nm, and still more preferably in a region of 410 nm to 420 nm.

Satisfying the spectral characteristic (i-11) means that a shielding property in the ultraviolet light region is excellent.

The average transmittance T_{370-400(0deg)AVE} is more preferably 8% or less, and still more preferably 6% or less.

The spectral characteristics (i-10) and (i-11) can be achieved, for example, by using two or more types of ultraviolet ray absorbing dyes.

The optical filter according to the present invention preferably satisfies the following spectral characteristic (i-12).

(i-12) when the dielectric multilayer film 1 side is set as an incident direction, an absolute value of a difference between a wavelength IR_R_{50(5deg)} at which a reflectance is 50% at an incident angle of 5 degrees in a wavelength region of 750 nm to 900 nm and a wavelength IR_T_{50(5deg)} at which a transmittance is 50% at an incident angle of 5 degrees in a wavelength region of 500 nm to 700 nm is 145 nm or more

Satisfying the spectral characteristic (i-12) means that a light-blocking region of the reflection characteristic is separated from a light-blocking region of the absorption characteristic.

The absolute value of the difference in the spectral characteristic (i-12) is more preferably 155 nm or more, and still more preferably 165 nm or more.

The spectral characteristic (i-12) can be achieved, for example, by using the dielectric multilayer film 21 to be described later.

The optical filter according to the present invention preferably satisfies the following spectral characteristic (i-13). It is preferable that the following spectral characteristic (i-14) is satisfied.

(i-13) an average value of absorption loss amount₃₇₀₋₄₀₀ in a wavelength of 370 nm to 400 nm is 9% or more
(i-14) an average value of absorption loss amount₇₀₀₋₈₀₀ in a wavelength of 700 nm to 800 nm is 70% or more

When the dielectric multilayer film 1 side is set as the incident direction, an absorption loss amount_{X-Y} in a wavelength of X nm to Y nm is defined as follows.

$$( Absorption loss {amount}_{X - Y} ) [ \% ] = 100 - ( transmittance at incident angle of 5 degrees ) - ( reflectance at incident angle of 5 degrees )$$

A larger absorption loss amount indicates that more light in that wavelength range is absorbed.

Satisfying the spectral characteristics (i-13) and (i-14) means that the ultraviolet light region and the near-infrared light region are blocked by the absorption characteristics.

The average value of absorption loss amount₃₇₀₋₄₀₀ is more preferably 30% or more, and still more preferably 50% or more.

The average value of absorption loss amount₇₀₀₋₈₀₀ is more preferably 75% or more, still more preferably 80% or more, and particularly preferably 90% or more.

The spectral characteristics (i-13) and (i-14) can be achieved, for example, by using an ultraviolet ray absorbing dye having a maximum absorption wavelength in a wavelength region of 350 nm to 420 nm and a near-infrared ray absorbing dye having a maximum absorption wavelength in a wavelength region of 700 nm to 800 nm.

The optical filter according to the present embodiment preferably satisfies all of the following spectral characteristics (i-15) to (i-17).
(i-15) when a dielectric multilayer film 1 side is set as an incident direction, an average reflectance R1_{430-650(5deg)AVE} in a wavelength of 430 nm to 650 nm and at an incident angle of 5 degrees is 2% or less
(i-16) when a dielectric multilayer film 1 side is set as an incident direction, an average reflectance R1_{430-650(60deg)AVE} in a wavelength of 430 nm to 650 nm and at an incident angle of 60 degrees is 9% or less
(i-17) when a dielectric multilayer film 1 side is set as an incident direction, an average reflectance R1_{840-960(5deg)AVE} in a wavelength of 840 nm to 960 nm and at an incident angle of 5 degrees is 85% or more.

Satisfying the spectral characteristics (i-15) to (i-17) substantially means that the dielectric multilayer film 1 has small reflection characteristics in the visible light region even at a high incident angle, and has reflection characteristics in the near-infrared light region having a wavelength of 840 nm to 960 nm.

The average reflectance R1_{430-650(5deg)AVE} is more preferably 1.5% or less, and still more preferably 1% or less.

The average reflectance R1_{430-650(60deg)AVE} is more preferably 8.5% or less, and still more preferably 8% or less.

The average reflectance R1_{840-960(5deg)AVE} is more preferably 90% or less, and still more preferably 95% or less.

The above-described spectral characteristics can be achieved by designing the dielectric multilayer film 1 so as to have the above-described characteristics.

The optical filter according to the present invention preferably satisfies the following spectral characteristic (i-18).
(i-18) when a dielectric multilayer film 1 side is set as an incident direction, when a reflectance R1_{n(5deg)} (n: any integer) at each wavelength is read at an incident angle of 5 degrees and an interval of 1 nm from a wavelength of 840 nm toward a wavelength of 960 nm, the number of n at which the reflectance R1_{n(5deg)} is 93% or more is 75 or more

Satisfying the spectral characteristic (i-18) means that the near-infrared light region having a wavelength of 840 nm to 960 nm is blocked due to the reflection characteristics.

The number of n at which the reflectance R1_{n(5deg)} is 93% or more is more preferably 80 or more, still more preferably 85 or more, and particularly preferably 90 or more.

The spectral characteristic (i-18) can be achieved, for example, by using a dielectric multilayer film having a high reflectance in a wavelength of 800 nm to 1000 nm.

### <Near-Infrared Ray Absorbing Glass>

The near-infrared ray absorbing glass in the optical filter according to the present embodiment preferably satisfies all of the following spectral characteristics (ii-1) and (ii-2). It is preferable that the following spectral characteristic (ii-3) is satisfied.
(ii-1) an average transmittance T_{400-600(0deg)AVE} in a wavelength of 400 nm to 600 nm and at an incident angle of 0 degrees is 75% or more
(ii-2) an average transmittance T_{800-1200(0deg)AVE} in a wavelength of 800 nm to 1200 nm and at an incident angle of 0 degrees is 25% or less
(ii-3) a transmittance T_{1200(0deg)} at a wavelength of 1200 nm and an incident angle of 0 degrees is 25% or less

As illustrated in the spectral characteristics (ii-1) to (ii-3), the near-infrared ray absorbing glass has excellent transmissivity for visible light and absorbs near-infrared light in a wide range of 800 nm to 1200 nm. Accordingly, an optical filter can be obtained in which the near-infrared light region can be sufficiently shielded without enhancing the reflection characteristics of the dielectric multilayer film for the near-infrared light, and a change in spectral characteristic is small even at a high incident angle.

From the viewpoint of easily satisfying the above-described spectral characteristics, the near-infrared ray absorbing glass in the optical filter according to the present embodiment is preferably, for example, a phosphate glass, a fluorophosphate glass, a silicophosphate glass, or a sulfophosphate glass, which contains a near-infrared ray absorbing component such as iron or copper.

A thickness of the near-infrared ray absorbing glass in the optical filter according to the present embodiment is preferably 0.5 mm or less, and more preferably 0.4 mm or less. From the viewpoint of maintaining the strength of the element, the thickness is preferably 0.1 mm or more, and more preferably 0.15 mm or more.

### <Dielectric Multilayer Film>

The optical filter according to the present embodiment includes the dielectric multilayer film 1 and the dielectric multilayer film 2. At least one of the dielectric multilayer films is preferably designed as a reflection film that reflects a part of near-infrared light (hereinafter, also referred to as an “NIR reflection film”). The other one of the dielectric multilayer films may be designed as a reflection film having a reflection region outside the near-infrared region, or as an anti-reflection film.

It is preferable that the NIR reflection film has, for example, wavelength selectivity of transmitting visible light, transmitting near-infrared light in a transmission region of an absorption layer, and mainly reflecting other near-infrared light.

It is preferable that at least one of the dielectric multilayer films is a reflection film having a reflection characteristic in the near-infrared light region having a wavelength of 800 nm to 1000 nm, and light is blocked due to such a characteristic, as illustrated in the spectral characteristic (i-8) of the optical filter.

By combining such a reflection characteristic in a specific wavelength region with the absorption characteristics of the near-infrared ray absorbing dye and the near-infrared ray absorbing glass, a near-infrared light region having a wavelength of 800 nm to 1200 nm in a wide range can be blocked.

On the other hand, it is preferable that the dielectric multilayer film serving as the reflection film has a small change in reflection characteristics in the visible light region, as illustrated in the spectral characteristic (i-9) of the optical filter. Accordingly, an optical filter can be obtained in which the spectral characteristics in the visible light region are less likely to change depending on the incident angle and the ripple is reduced.

In view of the above, it is preferable that at least one of the dielectric multilayer films is designed as a reflection layer that does not reflect visible light but reflects near-infrared light (light having a wavelength of 800 nm to 1000 nm) at a light incident angle of 0 degrees and 60 degrees. The dielectric multilayer film 1 is preferably a reflection layer.

It is preferable that the other one of the dielectric multilayer films is designed as an anti-reflection layer having small reflection characteristics in both the visible light region and the near-infrared light region, as illustrated in the spectral characteristic (i-9) of the optical filter. The dielectric multilayer film 2 is preferably an anti-reflection layer.

The dielectric multilayer film is composed of, for example, a dielectric multilayer film in which dielectric films having different refractive indices are laminated. More specifically, examples of the dielectric films include a dielectric film having a low refractive index (low refractive index film), a dielectric film having a medium refractive index (medium refractive index film), and a dielectric film having a high refractive index (high refractive index film), and the dielectric multilayer film is composed of a dielectric multilayer film in which two or more of those dielectric films are laminated.

A refractive index of the high refractive index film at a wavelength of 500 nm is preferably 1.6 or more, more preferably 1.8 to 2.5, and particularly preferably 2.2 to 2.5. Examples of a material of the high refractive index film include Ta₂O₅, TiO₂, TiO, and Nb₂O₅. Other commercially available products thereof include OS50 (Ti₃O₅), OS10 (Ti₄O₇), OA500 (mixture of Ta₂O₅ and ZrO₂), and OA600(mixture of Ta₂O₅ and TiO₂) manufactured by Canon Optron, Inc. Among them, TiO₂ is preferable from the viewpoint of reproducibility in film formability and refractive index, stability, and the like.

A refractive index of the medium refractive index film at a wavelength of 500 nm is preferably 1.6 or more and less than 2.2. Examples of a material of the medium refractive index film include ZrO₂, Nb₂O₅, Al₂O₃, HfO₂, OM-4, OM-6 (mixtures of Al₂O₃ and ZrO₂), and OA-100 sold by Canon Optron, Inc., and H4 and M2 (alumina lanthania) sold by Merck KGaA. Among them, Al₂O₃-based compounds and mixtures of Al₂O₃ and ZrO₂ are preferable from the viewpoint of reproducibility in film formability and refractive index, stability, and the like.

A refractive index of the low refractive index film at a wavelength of 500 nm is preferably less than 1.6, and more preferably 1.38 to 1.5. Examples of a material of the low refractive index film include SiO₂, SiOₓN_{y}, and MgF₂. Other commercially available products thereof include S4F and S5F (mixtures of SiO₂ and Al₂O₃) manufactured by Canon Optron, Inc. Among them, SiO₂ is preferable from the viewpoint of reproducibility in film formability, stability, economic efficiency, and the like.

In the dielectric multilayer film, [sum T(H) of QWOT of dielectric film having relatively high refractive index]/[sum T(L) of QWOT of dielectric film having relatively low refractive index] is preferably 1.6 or more. Accordingly, a dielectric multilayer film that satisfies the above spectral characteristic of reflecting near-infrared light having a wavelength of 800 nm to 1100 nm and preventing reflection of visible light can be easily obtained. It is preferable that at least the dielectric multilayer film laminated on a light incident side satisfies such a ratio relationship.

Here, a quater wave optical thickness (QWOT) is an optical thickness at λ/4 of a wavelength, and is calculated from a physical thickness using the following formula.

QWOT=physical thickness/central wavelength(500 nm)×4×refractive index at wavelength of 500 nm

When the dielectric multilayer film is a laminate of a low refractive index film and a high refractive index film, the sum T(H) of QWOT is a sum of QWOT of the high refractive index film, and the sum T(L) of QWOT is a sum of QWOT of the low refractive index film.

When the dielectric multilayer film is a laminate of a low refractive index film and a medium refractive index film, the sum T(H) of QWOT is a sum of QWOT of the medium refractive index film, and the sum T(L) of QWOT is a sum of QWOT of the low refractive index film.

When the dielectric multilayer film is a laminate of a medium refractive index film and a high refractive index film, the sum T(H) of QWOT is a sum of QWOT of the high refractive index film, and the sum T(L) of QWOT is a sum of QWOT of the medium refractive index film.

The dielectric multilayer film is preferably a multilayer film in which a H₂ layer and an M₂ layer, each defined below, are alternately laminated in 10 or more layers.

H₂ layer: a single layer having a refractive index of 1.8 or more and 2.5 or less and a QWOT of 1.1 or more and 3.5 or less.

M₂ layer: a single layer or a multilayer present between two H₂ layers and having a sum of QWOT of 1.2 or more and 1.8 or less.

The above specific laminated structure is a structure in which single layers (H₂ layers) having a large refractive index and a large optical thickness and layers (M₂ layers) whose total optical thickness is within a predetermined range are alternately laminated in 10 or more layers. With such a structure, it is easy to obtain a dielectric multilayer film that reflects near-infrared light having a wavelength of 800 nm to 1200 nm and has a low reflectance for visible light.

The M₂ layer may be a single layer or a multilayer as long as it has a predetermined optical thickness. From the viewpoint of obtaining smoother spectral characteristics, it is preferable that the M₂ layer is composed of a multilayer, and a minimum thickness of a single layer is preferably 5 nm or more, and more preferably 10 nm or more. A refractive index of the dielectric film constituting the M₂ layer is preferably equal to or lower than a refractive index of the H₂ layer.

It is preferable that at least the dielectric multilayer film designed as a reflection layer has the above specific laminated structure.

When the dielectric multilayer film designed as a reflection layer has the above laminated structure, it is preferable that, of the H₂ layer and the M₂ layer, the layer closest to the near-infrared ray absorbing glass is the H₂ layer. The H₂ layer closest to the near-infrared ray absorbing glass may be directly laminated on the near-infrared ray absorbing glass, or another layer not corresponding to either the H₂ layer or the M₂ layer may be present between the H₂ layer closest to the near-infrared ray absorbing glass and the near-infrared ray absorbing glass.

In the dielectric multilayer film designed as a reflection layer, a total number of laminated layers in the dielectric multilayer film is preferably 10 or more, more preferably 20 or more, and still more preferably 30 or more. When the total number of laminated layers is increased, warpage or the like occurs, or the thickness thereof is increased, so that the total number of laminated layers is preferably 110 or less, more preferably 80 or less, and still more preferably 60 or less.

The thickness (physical thickness) of the dielectric multilayer film designed as a reflection layer is preferably 1 μm to 6 μm as a whole.

When the optical filter is mounted on an imaging device, the dielectric multilayer film on a sensor side is generally preferably designed as an anti-reflection layer. The total number of laminated layers in the dielectric multilayer film designed as an anti-reflection layer is preferably 40 or less, more preferably 30 or less, and still more preferably 20 or less, and is preferably 6 or more.

The thickness (physical thickness) of the dielectric multilayer film designed as an anti-reflection layer is preferably 0.2 μm to 1.0 μm as a whole.

For formation of the dielectric multilayer film, for example, a vacuum film formation process such as a CVD method, a sputtering method, or a vacuum deposition method, a wet film formation process such as a spraying method or a dipping method, or the like can be used.

When the optical filter is mounted on the imaging device, the dielectric multilayer film laminated on a glass surface is generally disposed on a lens side, and the dielectric multilayer film laminated on a resin film surface is generally disposed on a sensor side.

### <Resin Film>

The resin film in the optical filter according to the present embodiment contains a resin, a near-infrared ray absorbing dye, and an ultraviolet ray absorbing dye. Here, the resin refers to a resin constituting the resin film.

As the near-infrared ray absorbing dye, a dye having a maximum absorption wavelength in 700 nm to 800 nm in the resin is preferred. In particular, a dye having a maximum absorption wavelength in 700 nm to 800 nm, a steep rise in absorption, and a small absorption loss in the visible light region is preferred. Accordingly, an optical filter having small incident angle dependency while maintaining a high transmittance in a red band (600 nm to 700 nm) can be obtained.

Examples of the near-infrared ray absorbing dye include at least one selected from the group consisting of a cyanine dye, a phthalocyanine dye, a squarylium dye, a naphthalocyanine dye, and a diimonium dye, and one thereof or a plurality thereof as a mixture can be used. Among them, a squarylium dye and a cyanine dye are preferred from the viewpoint of being able to steeply absorb light in a 700 nm to 800 nm region and thus being able to easily exert the effects of the present invention. It is preferable to use two or more near-infrared ray absorbing dyes. Accordingly, high visible light transmissivity can be easily maintained.

A content of the near-infrared ray absorbing dye in the resin film is preferably 0.1 parts by mass to 30 parts by mass, and more preferably 0.1 parts by mass to 20 parts by mass with respect to 100 parts by mass of the resin. When two or more compounds are combined, the above content is a sum of respective compounds.

As the ultraviolet ray absorbing dye, a dye having a maximum absorption wavelength in 350 nm to 420 nm in the resin is preferred. In particular, a dye having a maximum absorption wavelength in 350 nm to 420 nm and a steep rise in absorption is preferred. Accordingly, an optical filter having a small absorption loss in the visible color region while efficiently cutting the ultraviolet light region can be obtained.

Examples of the ultraviolet ray absorbing dye include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye.

Among them, the merocyanine dye is particularly preferred. These dyes may be used alone, or may be used in combination of two or more kinds thereof. It is preferable to use two or more ultraviolet ray absorbing dyes. Accordingly, high visible light transmissivity can be easily maintained.

A content of the ultraviolet ray absorbing dye in the resin film is preferably 0.5 parts by mass to 20 parts by mass, and more preferably 1 part by mass to 10 parts by mass with respect to 100 parts by mass of the resin. When two or more compounds are combined, the above content is a sum of respective compounds.

The resin is not limited as long as it is a transparent resin, and one or more kinds of transparent resins selected from a polyester resin, an acrylic resin, an epoxy resin, an ene-thiol resin, a polycarbonate resin, a polyether resin, a polyarylate resin, a polysulfone resin, a polyethersulfone resin, a poly(p-phenylene) resin, a polyarylene ether phosphine oxide resin, a polyamide resin, a polyimide resin, a polyamide-imide resin, a polyolefin resin, a cyclic olefin resin, a polyurethane resin, a polystyrene resin, and the like are used. These resins may be used alone, or may be used by mixing two or more kinds thereof.

One or more kinds of resins selected from the polyimide resin, the polycarbonate resin, the polyester resin, and the acrylic resin are preferable from the viewpoint of spectral characteristics, a glass transition temperature (Tg), and adhesion of the resin film.

In the case where a plurality of dyes are used, these dyes may be contained in the same resin film or may be contained in different resin films.

The resin film can be formed by dissolving or dispersing a dye, a resin or a raw material component of the resin, and respective components blended as necessary in a solvent to prepare a coating solution, applying the coating solution to a support, drying the coating solution, and further curing the coating solution as necessary. The support in this case may be the near-infrared ray absorbing glass used for the present filter, or may be a peelable support used only when the resin film is to be formed. The solvent may be a dispersion medium capable of stably dispersing components or a solvent capable of dissolving components.

The coating solution may contain a surfactant in order to improve voids due to fine bubbles, depressions due to adhesion of foreign matters and the like, and repelling in a drying step. For the application of the coating solution, for example, a dip coating method, a cast coating method, or a spin coating method can be used. The above coating solution is applied onto the support and then dried to form a resin film. When the coating solution contains a raw material component of the transparent resin, a curing process such as thermal curing or photocuring is further performed.

The resin film can also be manufactured into a film shape by extrusion molding. A substrate can be manufactured by laminating the obtained film-shaped resin film on the phosphate glass and integrating the resin film and the phosphate glass by thermal press fitting or the like.

The optical filter may include one layer of the resin film, or may have two or more layers of the resin film. When the optical filter includes two or more layers of the resin film, respective layers may have the same configuration or different configurations. When the optical filter includes two or more layers of the resin film, they may all be laminated on the same main surface side of the near-infrared ray absorbing glass, or each may be laminated on a different main surface side.

A thickness of the resin film is 10 μm or less and preferably 5 μm or less from the viewpoint of in-plane thickness distribution and appearance quality in a substrate after coating, and is preferably 0.5 μm or more from the viewpoint of exhibiting desired spectral characteristics at an appropriate dye concentration. When the optical filter includes two or more layers of resin films, a total thickness of the respective resin films is preferably within the above range.

The optical filter of the present embodiment may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have a high visible light transmittance and have light absorbing properties in a wide range of an infrared wavelength region exceeding 1,200 nm, and thus can be used in the case where light-shielding properties of infrared light are required.

For example, when the optical filter of the present embodiment is used in an imaging device such as a digital still camera, an imaging device having excellent color reproducibility can be provided. Such an imaging device includes a solid state image sensor, an imaging lens, and the optical filter of the present embodiment. The optical filter of the present embodiment can be used, for example, by being disposed between the imaging lens and the solid state image sensor, or by being directly attached to the solid state image sensor, the imaging lens, or the like of the imaging device via an adhesive layer.

As described above, the present description discloses the following optical filter and imaging device.

[1] An optical filter including:
a dielectric multilayer film 1;
a substrate comprising a near-infrared ray absorbing glass and a resin film; and
a dielectric multilayer film 2 in this order,
in which the resin film includes a near-infrared ray absorbing dye, an ultraviolet ray absorbing dye, and a resin, and
the optical filter satisfies all of the following spectral characteristics (i-1) to (i-9),
(i-1) an absolute value of a difference between an average transmittance T_{440-600(0deg)AVE} in a wavelength of 440 nm to 600 nm and at an incident angle of 0 degrees and an average transmittance T_{440-600(60deg)AVE} in a wavelength of 440 nm to 600 nm and at an incident angle of 60 degrees is 12% or less
(i-2) the average transmittance T_{440-600(0deg)AVE} is 78% or more
(i-3) a wavelength IR_T_{50(0deg)} at which a transmittance is 50% at an incident angle of 0 degrees is in a wavelength region of 590 nm to 640 nm
(i-4) an average transmittance T_{700-800(0deg)AVE} in a wavelength of 700 nm to 800 nm and at an incident angle of 0 degrees is 1% or less
(i-5) an average transmittance T_{800-1200(0deg)AVE} in a wavelength of 800 nm to 1200 nm and at an incident angle of 0 degrees is 5% or less
(i-6) when a dielectric multilayer film 1 side is set as an incident direction, an average reflectance R1_{370-420(5deg)AVE} in a wavelength of 370 nm to 420 nm and at an incident angle of 5 degrees is 65% or less
(i-7) when a dielectric multilayer film 1 side is set as an incident direction, a wavelength IR1_R_{50(5deg)} at which a reflectance is 50% at an incident angle of 5 degrees is in a wavelength range of 790 nm to 860 nm
(i-8) when a dielectric multilayer film 1 side is set as an incident direction, an average reflectance R1_{800-1000(5deg)AVE} in a wavelength of 800 nm to 1000 nm and at an incident angle of 5 degrees is 75% or more
(i-9) when a dielectric multilayer film 2 side is set as an incident direction, an average reflectance R2_{400-800(5deg)AVE} in a wavelength of 400 nm to 800 nm and at an incident angle of 5 degrees is 2% or less.

[2] The optical filter according to [1], in which the optical filter satisfies all of the following spectral characteristics (i-10) and (i-11),
(i-10) a wavelength UV_T_{50(0deg)} at which a transmittance is 50% at an incident angle of 0 degrees is in a region of 400 nm to 420 nm
(i-11) an average transmittance T_{370-400(0deg)AVE} in a wavelength of 370 nm to 400 nm and at an incident angle of 0 degrees is 10% or less.

[3] The optical filter according to [1] or [2], in which the optical filter satisfies the following spectral characteristic (i-12),
(i-12) when a dielectric multilayer film 1 side is set as an incident direction, an absolute value of a difference between a wavelength IR_R_{50(5deg)} at which a reflectance is 50% at an incident angle of 5 degrees in a wavelength region of 750 nm to 900 nm and a wavelength IR_T_{50(5deg)} at which a transmittance is 50% at an incident angle of 5 degrees in a wavelength region of 500 nm to 700 nm is 145 nm or more.

[4] The optical filter according to any one of [1] to [3], in which the optical filter satisfies the following spectral characteristic (i-13),
(i-13) an average value of absorption loss amount₃₇₀₋₄₀₀ in a wavelength of 370 nm to 400 nm is 9% or more
in which when a dielectric multilayer film 1 side is set as an incident direction, an absorption loss amount_{X-Y} in a wavelength of X nm to Y nm is defined as follows:

$$( Absorption loss {amount}_{X - Y} ) [ \% ] = 100 - ( transmittance at incident angle of 5 degrees ) - ( reflectance at incident angle of 5 degrees ) .$$

[5] The optical filter according to any one of [1] to [4], in which the optical filter further satisfies the following spectral characteristic (i-14),
(i-14) an average value of absorption loss amount₇₀₀₋₈₀₀ in a wavelength of 700 nm to 800 nm is 70% or more,
in which when a dielectric multilayer film 1 side is set as an incident direction, an absorption loss amount_{X-Y} in a wavelength of X nm to Y nm is defined as follows:

$$( Absorption loss {amount}_{X - Y} ) [ \% ] = 100 - ( transmittance at incident angle of 5 degrees ) - ( reflectance at incident angle of 5 degrees ) .$$

[5] The optical filter according to any one of [1] to [4], in which the optical filter satisfies all of the following spectral characteristics (i-15) to (i-17),
(i-15) when a dielectric multilayer film 1 side is set as an incident direction, an average reflectance R1_{430-650(5deg)AVE} in a wavelength of 430 nm to 650 nm and at an incident angle of 5 degrees is 2% or less
(i-16) when a dielectric multilayer film 1 side is set as an incident direction, an average reflectance R1_{430-650(60deg)AVE} in a wavelength of 430 nm to 650 nm and at an incident angle of 60 degrees is 9% or less
(i-17) when a dielectric multilayer film 1 side is set as an incident direction, an average reflectance R1_{840-960(5deg)AVE} in a wavelength of 840 nm to 960 nm and at an incident angle of 5 degrees is 85% or more.

[7] The optical filter according to any one of [1] to [6], in which the optical filter satisfies the following spectral characteristic (i-18),
(i-18) when a dielectric multilayer film 1 side is set as an incident direction, when a reflectance R1_{n(5deg)} (n: any integer) at each wavelength is read at an incident angle of 5 degrees and an interval of 1 nm from a wavelength of 840 nm toward a wavelength of 960 nm, the number of n at which the reflectance R1_{n(5deg)} is 93% or more is 75 or more.

[8] The optical filter according to any one of [1] to [7], in which the near-infrared ray absorbing glass satisfies all of the following spectral characteristics (ii-1) and (ii-2),
(ii-1) an average transmittance T_{400-600(0deg)AVE} in a wavelength of 400 nm to 600 nm and at an incident angle of 0 degrees is 75% or more
(ii-2) an average transmittance T_{800-1200(0deg)AVE} in a wavelength of 800 nm to 1200 nm and at an incident angle of 0 degrees is 25% or less.

[9] The optical filter according to any one of [1] to [8], in which the near-infrared ray absorbing glass satisfies the following spectral characteristic (ii-3),
(ii-3) a transmittance T_{1200(0deg)} at a wavelength of 1200 nm and an incident angle of 0 degrees is 25% or less.

The optical filter according to any one of [1] to [9], in which the resin film includes two or more of ultraviolet ray absorbing dyes having a maximum absorption wavelength in a region of 350 nm to 420 nm in the resin.

The optical filter according to any one of [1] to [10], in which the resin film includes two or more of near-infrared ray absorbing dyes having a maximum absorption wavelength in a region of 700 nm to 800 nm in the resin.

An imaging device including the optical filter according to any one of [1] to [11].

### EXAMPLES

Next, the present invention is described more specifically with reference to examples.

For measurement of each spectral characteristic, an ultraviolet-visible spectrophotometer (UH-4150 type, manufactured by Hitachi High-Tech Corporation) was used.

The spectral characteristic in the case where an incident angle is not particularly specified is a value measured at an incident angle of 0 degrees (in a direction perpendicular to a main surface of an optical filter).

Dyes used in respective examples are as follows.
Compound 1 (cyanine compound): synthesized based on a method described in Dyes and Pigments, 73, 344 to 352 (2007).
Compound 2 (squarylium compound): synthesized based on WO2017/135359.
Compound 3 (merocyanine compound): synthesized based on the description of German Patent No. 10109243.
Compound 4 (squarylium compound): synthesized based on JP2017-110209A.

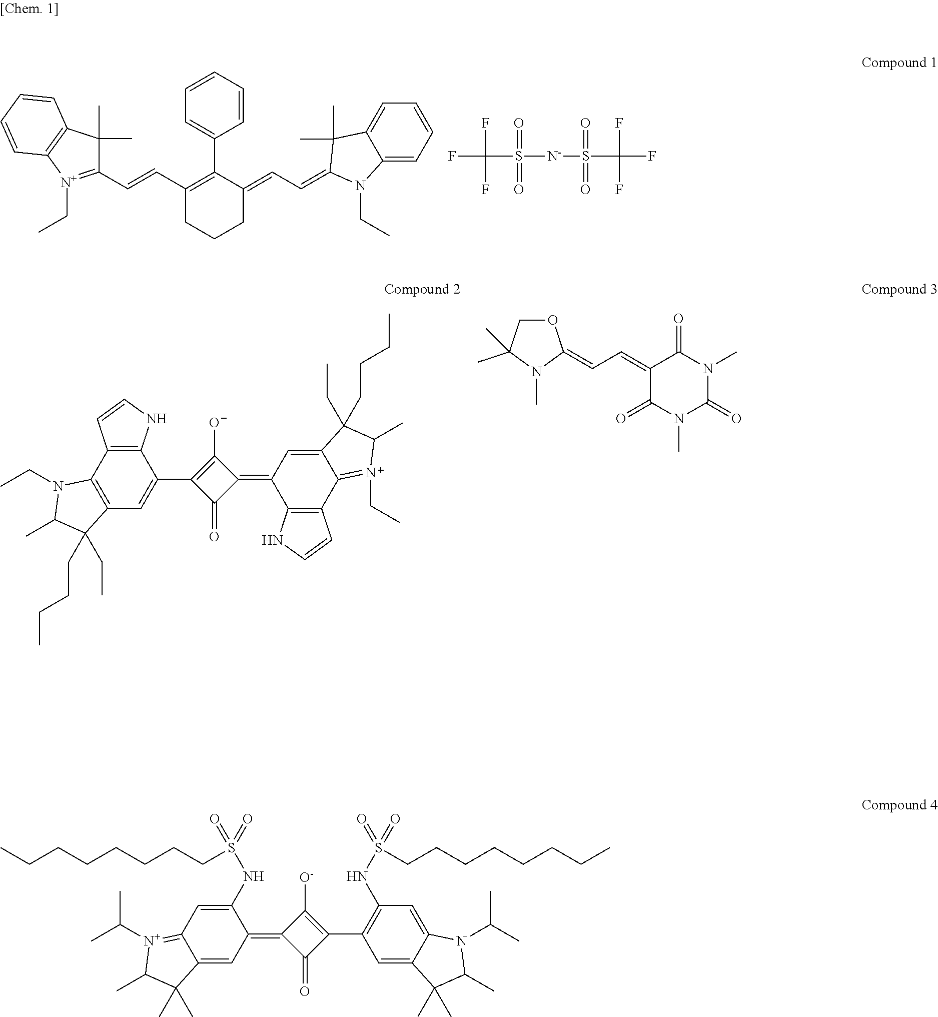

A maximum absorption wavelength of each dye in a polyimide resin is illustrated in Table 2 to be described later.

### <Spectral Characteristics of Glass>

As glasses used in Inventive Examples and Comparative Examples, glasses illustrated below were prepared.
Glass 1 and glass 2: fluorophosphate glass (NF-50GX, manufactured by AGC TECHNO GLASS Co., Ltd.)
Glass 3: alkali glass (D263, manufactured by SCHOTT)
Glass 4: fluorophosphate glass (containing, in mass %, P⁵⁺: 34.9%, Al³⁺: 7.9%, Na⁺: 7.3%, K⁺: 13.7%, Ca²⁺: 4.8%, Sr²⁺: 7.2%, Ba²⁺: 15.5%, and Cu²⁺: 8.7%; when a total of components other than F⁻ contained in the glass is taken as 100 mass %, 14.2 mass % of F⁻ is contained on an external basis)

Among the above glasses, the glass 1, the glass 2, and the glass 4 are a near-infrared ray absorbing glass.

The spectral characteristics of each glass are illustrated in the following Table 1.

The spectral characteristics of each near-infrared ray absorbing glass are illustrated in Table 1.

TABLE 1

| | | Type | | | |
|---|---|---|---|---|---|
| | | Glass 1 | Glass 2 | | Glass 4 |
| | | Fluorophosphate | Fluorophosphate | Glass 3 | Fluorophosphate |
| | | glass | glass | Alkali Glass | glass |
| Glass | Thickness [mm] | 0.3 | 0.2 | 0.21 | 0.2 |
| Spectral | Wavelength 400- | 79.21 | 82.70 | 91.60 | 84.13 |
| characteristics | 600 nm, 0 deg | | | | |
| of glass | Average | | | | |
| | transmittance | | | | |
| | [%] | | | | |
| | Wavelength 800- | 1.91 | 6.06 | 91.97 | 8.65 |
| | 1200 nm, 0 deg | | | | |
| | Average | | | | |
| | transmittance | | | | |
| | [%] | | | | |
| | Wavelength | 7.93 | 17.88 | 92.00 | 21.76 |
| | 1200 nm, 0 deg | | | | |
| | Transmittance | | | | |
| | [%] | | | | |

As described above, it is clear that the glass 1 has a high transmittance in the visible light region and excellent light shielding properties in the near-infrared region.

### Example 1: Optical Filter

A resin film was formed on one main surface of a glass substrate of the glass 1 by the following method to produce a substrate including a glass substrate and a resin film. First, a polyimide resin (“C3G30G” (trade name), manufactured by Mitsubishi Gas Chemical Company, Inc., refractive index: 1.59) was dissolved in a mixture of γ-butyrolactone (GBL):cyclohexanone=1:1 (mass ratio) to prepare a polyimide resin solution having a resin concentration of 8.5 mass %. Each of the above dyes was added to a resin solution at a concentration illustrated in the following Table 2 per 100 parts by mass of resin, and the mixture was stirred and dissolved at 50° C. for 2 hours to obtain a coating solution. The obtained coating solution was applied to a glass substrate by a spin coating method to form a resin film 1 having a thickness of about 3 μm.

On the other main surface of the glass substrate, TiO₂ and SiO₂ were laminated by deposition in a configuration illustrated in the following Table 3 to form a dielectric multilayer film 1. On the surface of the resin film, TiO₂ and SiO₂ were laminated by deposition in a configuration illustrated in the following Table 4 to form a dielectric multilayer film 2.

In this manner, an optical filter having a structure of dielectric multilayer film 1 (Table 3)/glass 1/resin film 1/dielectric multilayer film 2 (Table 4) was prepared.

### Examples 2 to 6: Optical Filters

Optical filters were prepared in the same manner as in Example 1, except that the glass, the resin film, the dielectric multilayer film 1, and the dielectric multilayer film 2 were changed to the following configurations. A configuration of each dielectric multilayer film is illustrated in Tables 3 to 8.

Example 2: dielectric multilayer film 1 (Table 3)/glass 2/resin film 1/dielectric multilayer film 2 (Table 6)

Example 3: dielectric multilayer film 1 (Table 4)/glass 2/resin film 1/dielectric multilayer film 2 (Table 6)

Example 4: dielectric multilayer film 1 (Table 3)/glass 3/resin film 1/dielectric multilayer film 2 (Table 6)

Example 5: dielectric multilayer film 1 (Table 5)/glass 2/resin film 1/dielectric multilayer film 2 (Table 7)

Example 6: dielectric multilayer film 1 (Table 8)/glass 4/resin film 2/dielectric multilayer film 2 (Table 6)

With respect to each of the optical filters, spectral transmittance curves at an incident angle of 0 degrees and an incident angle of 60 degrees and a spectral reflectance curve at an incident angle of 5 degrees in a wavelength range of 300 nm to 1200 nm were measured using the ultraviolet-visible spectrophotometer.

Results are illustrated in Table 9 below.

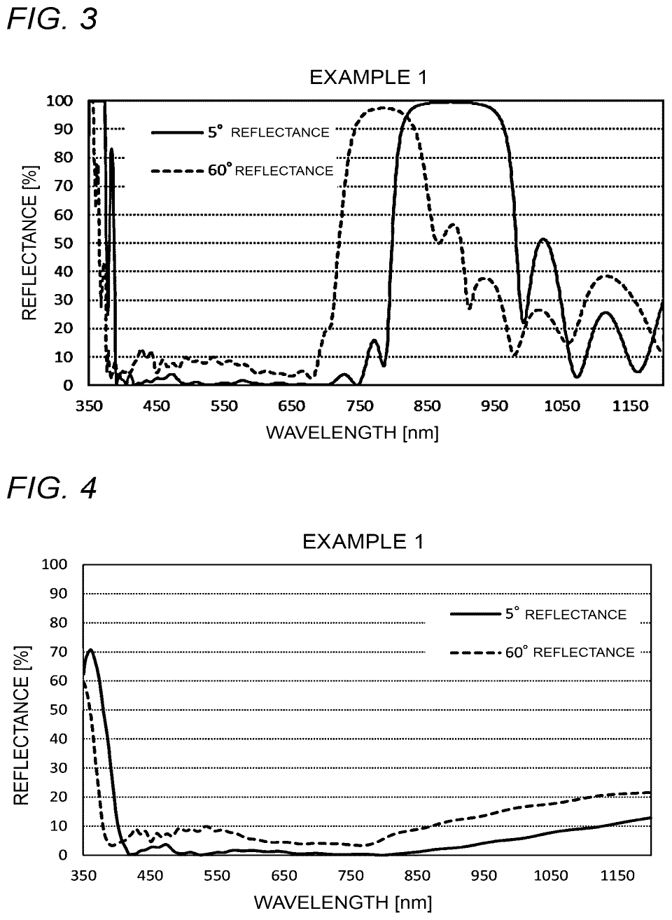

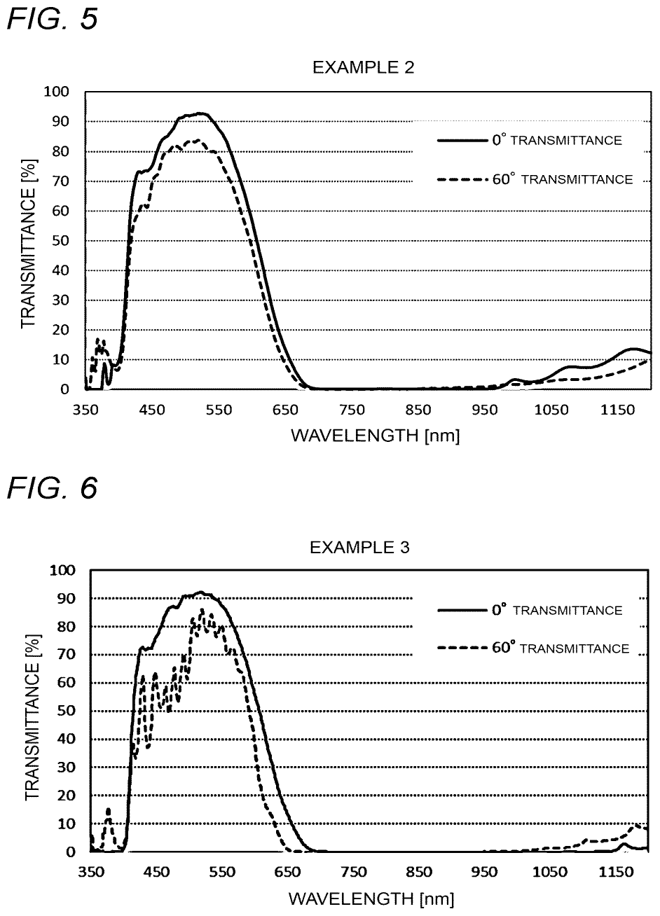

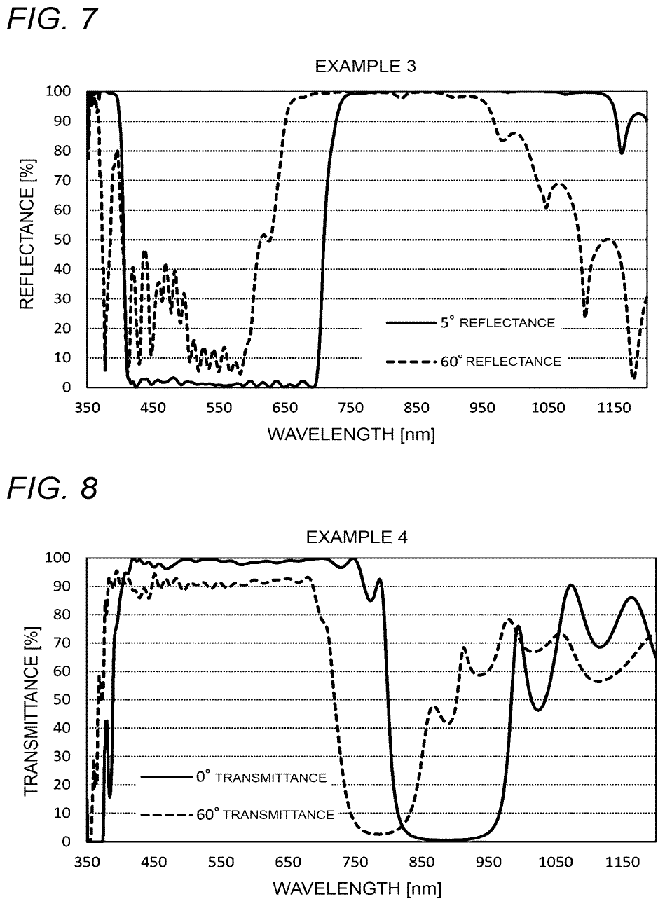

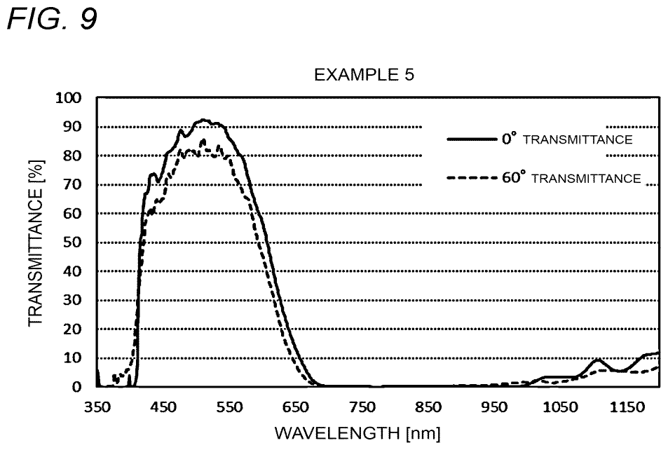

A spectral transmittance curve of the optical filter in Example 1 is illustrated in FIG. 2. A spectral reflectance curve on a dielectric multilayer film 1 side is illustrated in FIG. 3. A spectral reflectance curve on a dielectric multilayer film 2 side is illustrated in FIG. 4. A spectral transmittance curve of the optical filter in Example 2 is illustrated in FIG. 5. A spectral transmittance curve of the optical filter in Example 3 is illustrated in FIG. 6. A spectral reflectance curve on the dielectric multilayer film 1 side is illustrated in FIG. 7. A spectral transmittance curve of the optical filter in Example 4 is illustrated in FIG. 8. A spectral transmittance curve of the optical filter in Example 5 is illustrated in FIG. 9.

Examples 1, 2, and 6 are inventive examples, and Examples 3 to 5 are comparative examples.

TABLE 2

| | | Resin film 1 | Resin film 2 |
|---|---|---|---|
| Dye addition | Compound 1 (λMAX: 772 nm) | 3.6 | — |
| amount (mass %) | Compound 2 (λMAX: 752 nm) | 3.6 | 6.4 |
| | Compound 3 (λMAX: 397 nm) | 2.5 | 6.9 |
| | Compound 4 (λMAX: 706 nm) | 4.0 | — |
| | Total | 13.7 | 13.3 |

TABLE 3
Example 1, Example 2, Example 4 Dielectric multilayer film 1

| Film | Film | Physical |
|---|---|---|
| number | material | thickness [nm] |
| 1 | TiO₂ | 11.74 |
| 2 | SiO₂ | 29.31 |
| 3 | TiO₂ | 118.55 |
| 4 | SiO₂ | 29.98 |
| 5 | TiO₂ | 28.38 |
| 6 | SiO₂ | 31.2 |
| 7 | TiO₂ | 120.44 |
| 8 | SiO₂ | 33.15 |
| 9 | TiO₂ | 25.3 |
| 10 | SiO₂ | 33.27 |
| 11 | TiO₂ | 117.26 |
| 12 | SiO₂ | 30.31 |
| 13 | TiO₂ | 26.13 |
| 14 | SiO₂ | 32.8 |
| 15 | TiO₂ | 119 |
| 16 | SiO₂ | 40.7 |
| 17 | TiO₂ | 22.87 |
| 18 | SiO₂ | 41.01 |
| 19 | TiO₂ | 119.19 |
| 20 | SiO₂ | 39.02 |
| 21 | TiO₂ | 21.05 |
| 22 | SiO₂ | 39.63 |
| 23 | TiO₂ | 112.61 |
| 24 | SiO₂ | 33.84 |
| 25 | TiO₂ | 23.38 |
| 26 | SiO₂ | 35.28 |
| 27 | TiO₂ | 113.57 |
| 28 | SiO₂ | 44.5 |
| 29 | TiO₂ | 19.26 |
| 30 | SiO₂ | 49.32 |
| 31 | TiO₂ | 110.97 |
| 32 | SiO₂ | 58.05 |
| 33 | TiO₂ | 14.76 |
| 34 | SiO₂ | 52.97 |
| 35 | TiO₂ | 111.01 |
| 36 | SiO₂ | 44.89 |
| 37 | TiO₂ | 19.23 |
| 38 | SiO₂ | 40.73 |
| 39 | TiO₂ | 108.69 |
| 40 | SiO₂ | 44.92 |
| 41 | TiO₂ | 18.64 |
| 42 | SiO₂ | 44.69 |
| 43 | TiO₂ | 111.86 |
| 44 | SiO₂ | 49.8 |
| 45 | TiO₂ | 17.79 |
| 46 | SiO₂ | 45.07 |
| 47 | TiO₂ | 102.27 |
| 48 | SiO₂ | 84.34 |

TABLE 4
Example 3 Dielectric multilayer film 1

| Film | Film | Physical |
|---|---|---|
| number | material | thickness [nm] |
| 1 | TiO₂ | 12.39 |
| 2 | SiO₂ | 36.02 |
| 3 | TiO₂ | 112.83 |
| 4 | SiO₂ | 179.08 |
| 5 | TiO₂ | 111.35 |
| 6 | SiO₂ | 185.42 |
| 7 | TiO₂ | 111.64 |
| 8 | SiO₂ | 186.87 |
| 9 | TiO₂ | 110.92 |
| 10 | SiO₂ | 185.47 |
| 11 | TiO₂ | 110.36 |
| 12 | SiO₂ | 182.41 |
| 13 | TiO₂ | 104.66 |
| 14 | SiO₂ | 174.4 |
| 15 | TiO₂ | 98.8 |
| 16 | SiO₂ | 167.23 |
| 17 | TiO₂ | 97.6 |
| 18 | SiO₂ | 170.25 |
| 19 | TiO₂ | 100.42 |
| 20 | SiO₂ | 169.72 |
| 21 | TiO₂ | 95.07 |
| 22 | SiO₂ | 159.59 |
| 23 | TiO₂ | 88.1 |
| 24 | SiO₂ | 150.47 |
| 25 | TiO₂ | 84.87 |
| 26 | SiO₂ | 146.7 |
| 27 | TiO₂ | 84.15 |
| 28 | SiO₂ | 145.14 |
| 29 | TiO₂ | 84.06 |
| 30 | SiO₂ | 143.34 |
| 31 | TiO₂ | 84.45 |
| 32 | SiO₂ | 146.67 |
| 33 | TiO₂ | 83.68 |
| 34 | SiO₂ | 147.91 |
| 35 | TiO₂ | 83.85 |
| 36 | SiO₂ | 148.12 |
| 37 | TiO₂ | 89.24 |
| 38 | SiO₂ | 156.89 |
| 39 | TiO₂ | 87.45 |
| 40 | SiO₂ | 75.52 |

TABLE 5
Example 5 Dielectric multilayer film 1

| Film | Film | Physical |
|---|---|---|
| number | material | thickness [nm] |
| 1 | TiO₂ | 14.13 |
| 2 | SiO₂ | 31.29 |
| 3 | TiO₂ | 130.12 |
| 4 | SiO₂ | 34.65 |
| 5 | TiO₂ | 29.06 |
| 6 | SiO₂ | 36.31 |
| 7 | TiO₂ | 128.56 |
| 8 | SiO₂ | 31.05 |
| 9 | TiO₂ | 29.12 |
| 10 | SiO₂ | 26.47 |
| 11 | TiO₂ | 121.39 |
| 12 | SiO₂ | 26.83 |
| 13 | TiO₂ | 29.71 |
| 14 | SiO₂ | 30.42 |
| 15 | TiO₂ | 127.01 |
| 16 | SiO₂ | 32.85 |
| 17 | TiO₂ | 28.38 |
| 18 | SiO₂ | 32.45 |
| 19 | TiO₂ | 128.71 |
| 20 | SiO₂ | 30.3 |
| 21 | TiO₂ | 30.1 |
| 22 | SiO₂ | 30.61 |
| 23 | TiO₂ | 130.84 |
| 24 | SiO₂ | 28.49 |
| 25 | TiO₂ | 31.49 |
| 26 | SiO₂ | 29.25 |
| 27 | TiO₂ | 129.81 |
| 28 | SiO₂ | 34.42 |
| 29 | TiO₂ | 27.73 |
| 30 | SiO₂ | 36.39 |
| 31 | TiO₂ | 125.82 |
| 32 | SiO₂ | 41.15 |
| 33 | TiO₂ | 24.01 |
| 34 | SiO₂ | 41.61 |
| 35 | TiO₂ | 122.19 |
| 36 | SiO₂ | 39.07 |
| 37 | TiO₂ | 24.43 |
| 38 | SiO₂ | 37.61 |
| 39 | TiO₂ | 118.75 |
| 40 | SiO₂ | 39.26 |
| 41 | TiO₂ | 23.13 |
| 42 | SiO₂ | 39.69 |
| 43 | TiO₂ | 119.92 |
| 44 | SiO₂ | 45.28 |
| 45 | TiO₂ | 20.53 |
| 46 | SiO₂ | 47.44 |
| 47 | TiO₂ | 110.95 |
| 48 | SiO₂ | 93.65 |

TABLE 6
Example 1, Example 2, Example 3, Example
4 Dielectric multilayer film 2

| Film | Film | Physical |
|---|---|---|
| number | material | thickness [nm] |
| 1 | TiO₂ | 8.99 |
| 2 | SiO₂ | 62.65 |
| 3 | TiO₂ | 23.88 |
| 4 | SiO₂ | 25.54 |
| 5 | TiO₂ | 76.79 |
| 6 | SiO₂ | 13.2 |
| 7 | TiO₂ | 28.74 |
| 8 | SiO₂ | 103.77 |

TABLE 7
Example 5 Dielectric multilayer film 2

| Film | Film | Physical |
|---|---|---|
| number | material | thickness [nm] |
| 1 | TiO₂ | 12.39 |
| 2 | SiO₂ | 32.72 |
| 3 | TiO₂ | 125.53 |
| 4 | SiO₂ | 36.14 |
| 5 | TiO₂ | 27.62 |
| 6 | SiO₂ | 29.76 |
| 7 | TiO₂ | 97.77 |
| 8 | SiO₂ | 29.23 |
| 9 | TiO₂ | 25.61 |
| 10 | SiO₂ | 42.36 |
| 11 | TiO₂ | 126.41 |
| 12 | SiO₂ | 33.58 |
| 13 | TiO₂ | 29.52 |
| 14 | SiO₂ | 17.65 |
| 15 | TiO₂ | 100.02 |
| 16 | SiO₂ | 31.48 |
| 17 | TiO₂ | 28.54 |
| 18 | SiO₂ | 30.24 |
| 19 | TiO₂ | 100.14 |
| 20 | SiO₂ | 19.34 |
| 21 | TiO₂ | 29.07 |
| 22 | SiO₂ | 31.64 |
| 23 | TiO₂ | 124.58 |
| 24 | SiO₂ | 30.33 |
| 25 | TiO₂ | 30.96 |
| 26 | SiO₂ | 21.8 |
| 27 | TiO₂ | 74.76 |
| 28 | SiO₂ | 20.54 |
| 29 | TiO₂ | 32.58 |
| 30 | SiO₂ | 36.59 |
| 31 | TiO₂ | 126.36 |
| 32 | SiO₂ | 51.53 |
| 33 | TiO₂ | 24.7 |
| 34 | SiO₂ | 36.53 |
| 35 | TiO₂ | 74.86 |
| 36 | SiO₂ | 29.01 |
| 37 | TiO₂ | 27.96 |
| 38 | SiO₂ | 51.19 |
| 39 | TiO₂ | 124.32 |
| 40 | SiO₂ | 53.9 |
| 41 | TiO₂ | 25.6 |
| 42 | SiO₂ | 28.95 |
| 43 | TiO₂ | 76.78 |
| 44 | SiO₂ | 46.03 |
| 45 | TiO₂ | 15.86 |
| 46 | SiO₂ | 69.49 |
| 47 | TiO₂ | 109.53 |

Resin film 1

| | | |
|---|---|---|
| 1 | TiO₂ | 8.99 |
| 2 | SiO₂ | 62.65 |
| 3 | TiO₂ | 23.88 |
| 4 | SiO₂ | 25.54 |
| 5 | TiO₂ | 76.79 |
| 6 | SiO₂ | 13.2 |
| 7 | TiO₂ | 28.74 |
| 8 | SiO₂ | 103.77 |

TABLE 8
Example 6 Dielectric multilayer film 1

| Film | Film | Physical |
|---|---|---|
| number | material | thickness [nm] |
| 1 | Al₂O₃ | 12.00 |
| 2 | TiO₂ | 12.00 |
| 3 | SiO₂ | 34.15 |
| 4 | TiO₂ | 117.29 |
| 5 | SiO₂ | 39.59 |
| 6 | TiO₂ | 23.07 |
| 7 | SiO₂ | 41.67 |
| 8 | TiO₂ | 116.75 |
| 9 | SiO₂ | 45.18 |
| 10 | TiO₂ | 19.22 |
| 11 | SiO₂ | 45.29 |
| 12 | TiO₂ | 111.37 |
| 13 | SiO₂ | 51.58 |
| 14 | TiO₂ | 15.70 |
| 15 | SiO₂ | 53.65 |
| 16 | TiO₂ | 110.69 |
| 17 | SiO₂ | 53.86 |
| 18 | TiO₂ | 14.69 |
| 19 | SiO₂ | 53.30 |
| 20 | TiO₂ | 107.31 |
| 21 | SiO₂ | 55.26 |
| 22 | TiO₂ | 12.93 |
| 23 | SiO₂ | 61.3 |
| 24 | TiO₂ | 109.66 |
| 25 | SiO₂ | 66.79 |
| 26 | TiO₂ | 12.00 |
| 27 | SiO₂ | 62.86 |
| 28 | TiO₂ | 118.46 |
| 29 | SiO₂ | 48.22 |
| 30 | TiO₂ | 23.55 |
| 31 | SiO₂ | 40.27 |
| 32 | TiO₂ | 137.00 |
| 33 | SiO₂ | 24.46 |
| 34 | TiO₂ | 39.16 |
| 35 | SiO₂ | 22.25 |
| 36 | TiO₂ | 144.97 |
| 37 | SiO₂ | 29.42 |
| 38 | TiO₂ | 30.99 |
| 39 | SiO₂ | 34.81 |
| 40 | TiO₂ | 126.83 |
| 41 | SiO₂ | 48.34 |
| 42 | TiO₂ | 19.43 |
| 43 | SiO₂ | 50.32 |
| 44 | TiO₂ | 116.83 |
| 45 | SiO₂ | 49.21 |
| 46 | TiO₂ | 18.77 |
| 47 | SiO₂ | 44.15 |
| 48 | TiO₂ | 103.58 |
| 49 | SiO₂ | 84.86 |

TABLE 9

| | | Example | Example | Example | Example | Example | Example |
|---|---|---|---|---|---|---|---|
| | | 1 | 2 | 3 | 4 | 5 | 6 |
| Dielectric | Number of laminated layers | 8 L | 8 L | 8 L | 8 L | 47 L/8 L | 8 L |
| multilayer | Thickness [μm] | 0.3 | 0.3 | 0.3 | 0.3 | 2.4/0.3 | 0.2 |
| film 2 | | | | | | | |
| Resin film | | Resin | Resin | Resin | Resin | Resin | Resin |
| | | film 1 | film 1 | film 1 | film 1 | film 1 | film 2 |
| Glass | Type | Glass 1 | Glass 2 | Glass 2 | Glass 3 | Glass 2 | Glass 4 |
| | Thickness [mm] | 0.3 | 0.2 | 0.2 | 0.21 | 0.2 | 0.2 |
| Dielectric | Number of laminated layers | 48 L | 48 L | 40 L | 48 L | 48 L | 49 L |
| multilayer | Thickness [μm] | 2.6 | 2.6 | 4.9 | 2.6 | 2.7 | 2.6 |
| film 1 | | | | | | | |
| Spectral | \|440-600 nm, 0 deg average | 9.2 | 9.0 | 16.9 | 7.8 | 8.9 | 9.0 |
| characteristics | transmittance - 440-600 nm, | | | | | | |
| of optical | 60 deg average | | | | | | |
| filter | transmittance\| [%] | | | | | | |
| | 440-600 nm, 0 deg average | 79.7 | 83.0 | 82.9 | 98.4 | 82.3 | 88.7 |
| | transmittance [%] | | | | | | |
| | Wavelength [nm] at which | 597 | 607 | 607 | 800 | 607 | 615 |
| | transmittance is 50% in | | | | | | |
| | wavelength 500-700 nm and | | | | | | |
| | at incident angle 0 deg | | | | | | |
| | 700-800 nm, 0 deg average | 0.0 | 0.1 | 0.0 | 92.5 | 0.0 | 1.0 |
| | transmittance [%] | | | | | | |
| | 800-1200 nm, 0 deg average | 1.4 | 4.1 | 0.2 | 41.5 | 3.0 | 3.4 |
| | transmittance [%] | | | | | | |
| | Multilayer film 1 side, | 27.2 | 27.3 | 69.9 | 36.5 | 73.5 | 53.9 |
| | 370-420 nm, 5 deg average | | | | | | |
| | reflectance [%] | | | | | | |
| | Wavelength [nm] at | 799 | 799 | 709 | 799 | 851 | 793 |
| | which reflectance is 50% | | | | | | |
| | in wavelength 500-700 nm | | | | | | |
| | and at incident angle | | | | | | |
| | 5 deg on multilayer film | | | | | | |
| | 1 side | | | | | | |
| | Multilayer film 1 side, | 88.4 | 88.4 | 100.0 | 88.6 | 75.3 | 93.2 |
| | 800-1000 nm, 5 deg average | | | | | | |
| | reflectance [%] | | | | | | |
| | Multilayer film 2 side, | 1.2 | 1.2 | 1.3 | 3.2 | 1.9 | 1.1 |
| | 400-800 nm, 5 deg average | | | | | | |
| | reflectance [%] | | | | | | |
| | Wavelength [nm] at which | 415 | 415 | 415 | 388 | 415 | 416 |
| | transmittance is 50% in | | | | | | |
| | wavelength 300-450 nm and | | | | | | |
| | at incident angle 0 deg | | | | | | |
| | 370-400 nm, 0 deg average | 4.8 | 5.2 | 0.1 | 42.4 | 0.2 | 0.2 |
| | transmittance [%] | | | | | | |
| | Absolute value [nm] of | 201 | 192 | 103 | 1 | 244 | 166 |
| | difference between wavelength | | | | | | |
| | at which reflectance is 50% | | | | | | |
| | in wavelength 750-900 nm and | | | | | | |
| | at incident angle 5 deg and | | | | | | |
| | wavelength at which | | | | | | |
| | transmittance is 50% in | | | | | | |
| | wavelength 500-700 nm and | | | | | | |
| | at incident angle 5 deg | | | | | | |
| | Average value [%] | 51.3 | 50.9 | 1.3 | 0.0 | 9.3 | 11.7 |
| | of absorption loss amount | | | | | | |
| | 370-400 | | | | | | |
| | Average value [%] | 91.9 | 91.8 | 12.8 | 0.0 | 97.6 | 88.5 |
| | of absorption loss amount | | | | | | |
| | 700-800 | | | | | | |
| | Multilayer film 1 side, | 1.1 | 1.2 | 1.4 | 1.5 | 1.7 | 1.2 |
| | 430-650 nm, 5 deg average | | | | | | |
| | reflectance [%] | | | | | | |
| | Multilayer film 1 side, | 98.6 | 98.6 | 100.0 | 98.6 | 87.0 | 93.4 |
| | 840-960 nm, 5 deg average | | | | | | |
| | reflectance [%] | | | | | | |
| | Multilayer film 1 side, | 7.1 | 7.4 | 27.3 | 9.2 | 7.8 | 8.2 |
| | 430-650 nm, 60 deg average | | | | | | |
| | reflectance [%] | | | | | | |
| | The number of wavelengths | 121 | 121 | 121 | 121 | 86 | 84 |
| | having reflectance of 93% | | | | | | |
| | or more in range of | | | | | | |
| | 840-960 nm on multilayer | | | | | | |
| | film 1 side | | | | | | |

From the above results, for the optical filters in Example 1, Example 2, and Example 6, the absolute value of the difference between the average transmittance T_{440-600(0deg)AVE} and the average transmittance T_{440-600(60deg)AVE} is 12% or less, the change in visible light transmittance is small even at a high incident angle of 60 degrees, and the average transmittance T_{440-600(0deg)AVE} is 78% or more, maintaining a high visible light transmittance. The wavelength IR_T_{50(0deg)} at which a transmittance is 50% at an incident angle of 0 degrees is in 590 nm to 640 nm. Further, the average transmittance T_{700-800(0deg)AVE} is 1% or less and the average transmittance T_{800-1200(0deg)AVE} is 5% or less, and the shielding property for near-infrared light is excellent in a wide range. In the optical filters in Examples 1, 2, and 6, from the result of the reflectance, one dielectric multilayer film has a low UV reflectance and a high reflectance in the near-infrared light region of 800 nm to 1000 nm, while the other dielectric multilayer film has a low reflectance in the visible light region of 400 nm to 800 nm and the near-infrared light region.

On the other hand, in the optical filter in Example 3, the absolute value of the difference between the average transmittance T_{440-600(0deg)AVE} and the average transmittance T_{440-600(60deg)AVE} exceeds 12%, and the change in visible light transmittance is large at a high incident angle. This is because the spectral characteristics of the dielectric multilayer film 1 greatly change depending on the incident angle.

In the optical filter in Example 4, the wavelength IR_T_{50(0deg)} deviates from a wavelength region of 590 nm to 640 nm, the average transmittanceT_{700-800(0deg)AVE} exceeds 1%, the average transmittanceT_{800-1200(0deg)AVE} exceeds 5%, and the shielding property of the near-infrared light is low. This is because the glass substrate does not have a characteristic of absorbing near-infrared light.

In the optical filter in Example 5, the average reflectance R_{370-420(5deg)AVE} on the dielectric multilayer film 1 side exceeds 65%, and the ultraviolet light reflectance is large. This is because the dielectric multilayer film 1 has a large ultraviolet light reflectance.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2022-210261) filed on Dec. 27, 2022, the content of which is incorporated herein by reference.

### INDUSTRIAL APPLICABILITY

The optical filter of the present embodiment has a small change in spectral characteristics even at a high incident angle, has excellent transmissivity in the visible light region, and excellent shielding properties in the near-infrared light region, particularly in a wide range including 1200 nm. In recent years, the optical filter is useful for applications of imaging devices such as cameras and sensors for transport machines, for which high performance has been achieved.

### REFERENCE SIGNS LIST

1B optical filter
10 near-infrared ray absorbing glass
21, 22 dielectric multilayer film
30 resin film
40 substrate

What is claimed is:

1. An optical filter comprising:
a dielectric multilayer film 1;
a substrate comprising a near-infrared ray absorbing glass and a resin film; and
a dielectric multilayer film 2 in this order,
wherein the resin film comprises a near-infrared ray absorbing dye, an ultraviolet ray absorbing dye, and a resin, and
the optical filter satisfies all of the following spectral characteristics (i-1) to (i-9),
(i-1) an absolute value of a difference between an average transmittance T_{440-600(0deg)AVE} in a wavelength of 440 nm to 600 nm and at an incident angle of 0 degrees and an average transmittance T_{440-600(60deg)AVE} in a wavelength of 440 nm to 600 nm and at an incident angle of 60 degrees is 12% or less
(i-2) the average transmittance T_{440-600(0deg)AVE} is 78% or more
(i-3) a wavelength IR_T_{50(0deg)} at which a transmittance is 50% at an incident angle of 0 degrees is in a wavelength region of 590 nm to 640 nm
(i-4) an average transmittance T_{700-800(0deg)AVE} in a wavelength of 700 nm to 800 nm and at an incident angle of 0 degrees is 1% or less
(i-5) an average transmittance T_{800-1200(0deg)AVE} in a wavelength of 800 nm to 1200 nm and at an incident angle of 0 degrees is 5% or less
(i-6) when a dielectric multilayer film 1 side is set as an incident direction, an average reflectance R1_{370-420(5deg)AVE} in a wavelength of 370 nm to 420 nm and at an incident angle of 5 degrees is 65% or less
(i-7) when a dielectric multilayer film 1 side is set as an incident direction, a wavelength IR1_R_{50(5deg)} at which a reflectance is 50% at an incident angle of 5 degrees is in a wavelength range of 790 nm to 860 nm
(i-8) when a dielectric multilayer film 1 side is set as an incident direction, an average reflectance R1_{800-1000(5deg)AVE} in a wavelength of 800 nm to 1000 nm and at an incident angle of 5 degrees is 75% or more
(i-9) when a dielectric multilayer film 2 side is set as an incident direction, an average reflectance R2_{400-800(5deg)AVE} in a wavelength of 400 nm to 800 nm and at an incident angle of 5 degrees is 2% or less.

2. The optical filter according to claim 1, wherein the optical filter satisfies all of the following spectral characteristics (i-10) and (i-11),
(i-10) a wavelength UV_T_{50(0deg)} at which a transmittance is 50% at an incident angle of 0 degrees is in a region of 400 nm to 420 nm
(i-11) an average transmittance T_{370-400(0deg)AVE} in a wavelength of 370 nm to 400 nm and at an incident angle of 0 degrees is 10% or less.

3. The optical filter according to claim 1, wherein the optical filter satisfies the following spectral characteristic (i-12),
(i-12) when a dielectric multilayer film 1 side is set as an incident direction, an absolute value of a difference between a wavelength IR_R_{50(5deg)} at which a reflectance is 50% at an incident angle of 5 degrees in a wavelength region of 750 nm to 900 nm and a wavelength IR_T_{50(5deg)} at which a transmittance is 50% at an incident angle of 5 degrees in a wavelength region of 500 nm to 700 nm is 145 nm or more.

4. The optical filter according to claim 1, wherein the optical filter satisfies the following spectral characteristic (i-13),
(i-13) an average value of absorption loss amount₃₇₀₋₄₀₀ in a wavelength of 370 nm to 400 nm is 9% or more wherein when a dielectric multilayer film 1 side is set as an incident direction, an absorption loss amount_{X-Y} in a wavelength of X nm to Y nm is defined as follows:
$$( Absorption loss {amount}_{X - Y} ) [ \% ] = 100 - ( transmittance at incident angle of 5 degrees ) - ( reflectance at incident angle of 5 degrees ) .$$

5. The optical filter according to claim 1, wherein the optical filter further satisfies the following spectral characteristic (i-14),
(i-14) an average value of absorption loss amount₇₀₀₋₈₀₀ in a wavelength of 700 nm to 800 nm is 70% or more,
wherein when a dielectric multilayer film 1 side is set as an incident direction, an absorption loss amount_{X-Y} in a wavelength of X nm to Y nm is defined as follows:
$$( Absorption loss {amount}_{X - Y} ) [ \% ] = 100 - ( transmittance at incident angle of 5 degrees ) - ( reflectance at incident angle of 5 degrees ) .$$

6. The optical filter according to claim 1, wherein the optical filter satisfies all of the following spectral characteristics (i-15) to (i-17),
(i-15) when a dielectric multilayer film 1 side is set as an incident direction, an average reflectance R1_{430-650(5deg)AVE} in a wavelength of 430 nm to 650 nm and at an incident angle of 5 degrees is 2% or less
(i-16) when a dielectric multilayer film 1 side is set as an incident direction, an average reflectance R1_{430-650(60deg)AVE} in a wavelength of 430 nm to 650 nm and at an incident angle of 60 degrees is 9% or less
(i-17) when a dielectric multilayer film 1 side is set as an incident direction, an average reflectance R1_{840-960(5deg)AVE} in a wavelength of 840 nm to 960 nm and at an incident angle of 5 degrees is 85% or more.

7. The optical filter according to claim 1, wherein the optical filter satisfies the following spectral characteristic (i-18),
(i-18) when a dielectric multilayer film 1 side is set as an incident direction, when a reflectance R1_{n(5deg)} (n: any integer) at each wavelength is read at an incident angle of 5 degrees and an interval of 1 nm from a wavelength of 840 nm toward a wavelength of 960 nm, the number of n at which the reflectance R1_{n(5deg)} is 93% or more is 75 or more.

8. The optical filter according to claim 1, wherein the near-infrared ray absorbing glass satisfies all of the following spectral characteristics (ii-1) and (ii-2),
(ii-1) an average transmittance T_{400-600(0deg)AVE} in a wavelength of 400 nm to 600 nm and at an incident angle of 0 degrees is 75% or more
(ii-2) an average transmittance T_{800-1200(0deg)AVE} in a wavelength of 800 nm to 1200 nm and at an incident angle of 0 degrees is 25% or less.

9. The optical filter according to claim 1, wherein the near-infrared ray absorbing glass satisfies the following spectral characteristic (ii-3),
(ii-3) a transmittance T_{1200(0deg)} at a wavelength of 1200 nm and an incident angle of 0 degrees is 25% or less.

10. The optical filter according to claim 1, wherein the resin film comprises two or more of ultraviolet ray absorbing dyes having a maximum absorption wavelength in a region of 350 nm to 420 nm in the resin.

11. The optical filter according to claim 1, wherein the resin film comprises two or more of near-infrared ray absorbing dyes having a maximum absorption wavelength in a region of 700 nm to 800 nm in the resin.

12. An imaging device comprising the optical filter according to claim 1.
